(19) United States
(12) Patent Application Publication
(10) Pub. No.: US 2018/0171845 A1
(43) Pub. Date: Jun. 21, 2018

(54) Turbocharged Engine Assembly With Two Exhaust Pipes And Regulating Valve

(71) Applicants: PSA AUTOMOBILES S.A., Poissy (FR); BorgWarner Inc., Auburn Hills, MI (US)

(72) Inventors: Diego Rafael Veiga Pagliari, Paris (FR); Arnaud Dupuis, Paris (FR); David Roth, Groton, NY (US)

(21) Appl. No.: 15/575,296

(22) PCT Filed: May 27, 2016
(86) PCT No.: PCT/FR2016/051275

§ 371 Date: Feb. 27, 2018

(30) Foreign Application Priority Data
Jun. 2, 2015 (FR) 1554986

(51) Int. Cl. F01N 3/20; F02B 37/02; F02B 37/18; F02B 37/20; F02D 41/00; F02D 41/02

(52) U.S. Cl. CPC F01N 3/2006; F02B 37/025; F02B 37/183; F01N 3/2066; F02D 41/0007; F02D 41/0055; F02D 41/0255; F02B 37/20

(57) ABSTRACT

The invention relates to an engine assembly (1) comprising a turbine (2) and an exhaust system removing the gasses from the engine and comprising a first pipe (4) leading from a first manifold (5) and a second discharge pipe (6) leading from a second manifold (7), the turbine (2) comprising a casing (2c) surrounding it and an energy-recovering impeller, the first pipe (4) opening into a main expansion passage housing the impeller. The second pipe (6) opens into at least one bypass portion (8) internal to the casing (2c) and bypassing the main expansion passage, the main expansion passage and said at least one bypass portion (8) meeting at an outlet face (2b) of the casing (2c), the main expansion passage comprising, inside the turbine (2), a valve for regulating the flow of exhaust gas passing through it.

### CROSS-REFERENCE TO RELATED APPLICATIONS

This application derives and claims priority from International Application PCT/FR2016/051275, filed May 27, 2016, and published under International Publication Number WO2016/193598, which derives priority from French application Serial No. 1554986, filed Jun. 2, 2015, and which are hereby incorporated by reference.

### BACKGROUND

The present invention relates to an engine assembly for a motor vehicle comprising an internal combustion engine, a turbocharger and an exhaust system comprising two exhaust ducts, the two extensions of which join inside the turbine. An extension of one of the two ducts called the exhaust duct passes through the turbine while exchanging energy therein with a turbine impeller, a regulation valve being placed in this extension while an extension of the other one of the two ducts called the discharge duct passes through the turbine but bypasses the turbine impeller.

The exhaust system of such an engine assembly is connected to an outlet of the turbocharged engine, also called a supercharged engine, to remove the exhaust gas resulting from the combustion in the engine, this engine being advantageously but not exclusively, a four-stroke gas engine.

FIG. 1 shows a supercharged gas engine assembly according to the closest state of the art described in particular in document WO-A-2009/105463. Such an engine assembly is known as a Valve Event Modulated Boost (VEMB) engine. This type of engine assembly will be described after the general presentation of a conventional supercharged engine and an engine equipped with an exhaust gas recirculation line at the engine intake, also called an EGR line.

Referring to FIG. 1, a combustion engine comprises a cylinder block provided with at least one cylinder, advantageously several cylinders, and an air intake inlet or air intake manifold for the air/gas mixture in each cylinder as well as an outlet for the exhaust gas resulting from the combustion of the mixture in each cylinder. The engine outlet is linked to an exhaust manifold 5 supplying an exhaust duct 4, 9 evacuating the exhaust gases to the outside.

The fact that two exhaust manifolds 5, 7, each with an associated exhaust duct 4, 6 are shown for the engine assembly in FIG. 1 is not applicable to every turbocharged engine assembly, such an engine usually comprising only one manifold 5 and only one exhaust duct 4, 9 which passes through a turbine 2.

The turbocharged engine comprises a turbine 2 and a compressor 3. The turbine 2 is arranged downstream of the exhaust manifold 5 in the exhaust duct 4 while the compressor 3 is arranged upstream of the engine air intake manifold. The turbine 2 comprises a turbine impeller recovering at least partially the kinetic energy created in the exhaust gases passing through it, the rotating element or impeller of the turbine being rotated by the exhaust gases leaving the exhaust manifold. The turbine 2 drives the compressor 3 by being secured to it by a shaft, the compressor 3 being passed through by the fresh air intended to supply the engine with air, which the compressor 3 compresses.

At the outlet of the compressor 3, this air t is called supercharged air and is conveyed by the air supply line towards a supercharged air cooler 25 to cool the air exiting the compressor 3. On this line a throttle valve 26 is also positioned, regulating the flow of air into the air intake manifold of the engine forming the engine air inlet.

On the exhaust side of the engine assembly 1, at the outlet of the turbine 2, the exhaust gases removed from the engine penetrate into the exhaust duct 9 of the motor vehicle after having passed through the turbine 2 and then pass through the exhaust gas depollution means 10, for example one or more catalytic converters, specifically means of oxidation, of reduction or three-way means associated with a particle filter or not. A Selective Catalytic Reduction system or SCR system can also be provided in the exhaust duct 9.

It is also common to provide an engine assembly with an exhaust gas recirculation line at the engine's air intake, also called an EGR line, said line being referenced as 11 in FIG. 1. It is known for positive-ignition and compression-ignition combustion engines to recirculate the exhaust gases towards the air intake of the combustion engine in order to reduce nitrogen oxide emissions. Such a system is also known by the acronym EGR, which stands for Exhaust Gas Recirculation.

An EGR line 11 has a branch point on the exhaust duct to draw off some of the exhaust gases from this duct as well as to coolant 23 the exhaust gases passing through this line 11, because these gases at that stage are very hot. The EGR line 11 opens into the air intake upstream of the compressor 3 that it supplies. A valve 24 called an EGR valve is fitted to the EGR line 11, preferably downstream of the cooler 23 in order to open or close the circulation of gases towards the intake.

For any type of EGR line 11, the recirculation of exhaust gases towards the air intake of the combustion engine improves the thermodynamic performance of the engine due to the reduction of heat transfer, which is a result of the reintroduction of recycled gases via the EGR line 11 into the intake manifold. Such recirculation can also reduce enrichment linked to the exhaust temperature and reduce pumping losses when the engine is associated with a turbocharger.

Efforts to reduce pumping losses have failed to achieve completely satisfactory results and pumping phenomena still persist in the turbine 2. It was proposed to use a discharge valve inside the turbine. An exhaust system was then proposed for a valve event modulated boost engine assembly with two exhaust ducts as shown in FIG. 1.

The combustion engine forming part of the valve event modulated boost engine assembly 1 has at least one cylinder, with three cylinders shown in FIG. 1. Each engine cylinder is provided with an intake valve and two exhaust valves. These exhaust valves are associated selectively with a first or a second outlet passage in a cylinder and selectively open and close their associated passage.

The same principle applies to the intake valve associated with an inlet passage in each cylinder. The two outlet passages of each cylinder that are closed and opened sequentially by their associated exhaust valve open into a different exhaust manifold 5, 7 each supplying a dedicated exhaust duct 4, 6, the two exhaust ducts 4, 6 not following the same route, as will be later described in detail. The first outlet passage of each cylinder is linked to the first manifold 5 and the second outlet passage is linked to the second manifold 7.

A valve event modulated boost engine assembly 1 therefore comprises an exhaust duct 4 through the turbine 2 leading from a first exhaust manifold 5 and a second so-called discharge duct 6 leading from a second exhaust manifold 7, the exhaust manifolds 5, 7 each being connected respectively to one of the two series of first or second exhaust passages equipped with their exhaust valves provided for each cylinder.

The first duct 4 leads to an inlet face of the turbine 2 of the turbocharger being extended by a main expansion passage inside the turbine 2 housing a turbine impeller allowing the kinetic energy contained in the exhaust gases passing through it to be recovered. The second duct 6 bypasses the turbine 2 without penetrating therein but joins further downstream of the turbine 2 a third duct 9 connected to an outlet face of the turbine 2 for the removal of the exhaust gases from the main expansion passage having exchanged energy with the turbine impeller so that only one single exhaust duct 9 passes through the decontamination elements 10 located at the end of the exhaust system. This means that, in such a valve event modulated boost engine according to the state of the art, the second duct 6 has no extension penetrating the turbine 2.

The function of the first duct 4 called the exhaust duct through the turbine is to allow a first flow of exhaust gas to pass through the turbine 2 and its rotating energy recovery device in the form of an impeller in order to provide power for the compressor 3. The function of the second duct 6 called the discharge duct supplied by a second exhaust manifold 7, different and independent from the first exhaust manifold 5 of the first duct 4, is to allow a second flow of exhaust gas independent and different from the first flow to bypass the turbine 2 and specifically its impeller and thus to discharge the turbine 2 of the total flow of exhaust gas while reducing the flow of exhaust gas passing through it by subtracting the second flow from the total flow.

This allows the power of the turbine to be discharged and/or controlled, as would, in the conventional operating condition of regulation of the engine load, a discharge valve, a device previously known in the state of the art for a turbocharged engine. This specifically avoids the pumping phenomenon of the compressor by involving a return of the hot gases to the intake air inlet.

For a conventional turbocharged engine, a discharge valve that can be internal or external to the turbine serves to limit the pressure of the exhaust gases on the turbocharger turbine impeller by opening a bypass for the exhaust gases so that they no longer pass through the turbine and its impeller. A limitation of the turbine impeller speed is thus achieved, which also limits the speed of rotation of the impeller provided in the compressor since it is secured to the turbine impeller, thus also limiting the compression of the intake air.

A discharge valve associated with a turbine to regulate the flow of exhaust gas passing through it is no longer necessary with a valve event modulated boost engine having two exhaust ducts each leading from a respective exhaust manifold.

Thus, such an engine assembly improves the efficiency of the engine cycle by reducing engine pumping during the exhaust phase of a four-stroke cycle, which has a favorable impact on engine consumption. A better control of the energy recovered by the turbine is thus achieved, which results in better management of engine load.

The drawback of such an engine assembly is the length of the second so-called discharge duct 6, which makes the incorporation of the exhaust system of such an assembly on the engine's exhaust front face more complicated, the available space being very small on this front face.

In this way, after the second exhaust duct 6 joins the third 9 removing the exhaust gases from the turbine, a higher exhaust gas temperature is reached than that of the flow of gas passing only through the turbine 2, the flow of exhaust gas passing through the second duct 6 losing significantly fewer degrees of heat than the flow of gas passing through the turbine 2 via the main expansion passage housing the energy-recovery impeller of the turbine 2.

This can be added to other advantages, specifically as regards the discharge and/or control of the turbine's power, as would, in the conventional operating condition of regulation of the engine load, a discharge valve, a device previously known in the state of the art for a conventional turbocharged engine. This specifically avoids the pumping phenomenon of the engine basically involving a return of the hot gases to the intake air inlet.

However, the temperature gain in the decontamination elements is not significant enough to avoid a long heating time of the exhaust gas decontamination elements located downstream of the turbine.

Document EP-B-1 097 298 describes an engine assembly with an exhaust system basically reiterating all of the characteristics previously mentioned for a valve event modulated boost engine assembly. This document discloses at least one regulation valve on the first duct, possibly arranged upstream of the turbine or downstream of the turbine but always outside the turbine.

However, such an arrangement of the valve outside the turbine creates heat loss from the exhaust gases in the first duct while increasing the space occupied by the exhaust system, all the more so because the second duct is forced to bypass the turbine to join the first duct. This also results in a loss of heat from the exhaust gases in the second duct due to the length thereof, which is detrimental to obtaining exhaust gases that are as hot as possible in the outlet area of the exhaust system, this outlet area incorporating the decontamination elements of the exhaust system.

Consequently, the problem at the heart of the invention is to improve a so-called valve event modulated boost engine assembly with two exhaust ducts whilst allowing, as required in certain engine operating conditions, the highest possible temperature of the gases in the exhaust system downstream of the turbine to be achieved without increasing the space occupied by the exhaust system and minimizing the heat losses in the system.

### SUMMARY

In order to achieve this objective, an engine assembly is provided according to the invention including an internal combustion engine with at least one cylinder, a turbocharger comprising a turbine and a compressor, and an exhaust system connected to an outlet of the engine in order to remove the exhaust gases resulting from the combustion in the engine, the exhaust system comprising a first so-called exhaust duct through the turbine leading from a first exhaust manifold and a second so-called discharge duct leading from a second exhaust manifold, the turbine being provided with a casing having a main expansion passage housing a turbine impeller and the first duct opening into the main expansion passage through an inlet face of the casing, characterized in that the second duct opens through the inlet face of the casing into at least one bypass portion inside the casing bypassing the main expansion passage, the main expansion passage and said at least one bypass portion joining at an outlet face of the casing, the main expansion passage comprising, inside the turbine, a valve for regulating the flow of exhaust gas passing through it.

The technical effect is to achieve a regulation of the temperature of the gases in the exhaust system downstream of the turbine by means of a simple and inexpensive means which is a regulation valve. In the particular and non-limiting case of improving the heating time of the decontamination elements located downstream of the turbine in the exhaust system, since the flow is reduced by the regulation valve in the first duct passing through the turbine impeller, the proportion of exhaust gases expanded in the impeller is lower and the gases passing through the decontamination elements after the joining of the first and second ducts have not for the most part been expanded and so retain a high temperature.

This is especially valid for engine assembly operating conditions at low engine speeds and loads corresponding to a plenum pressure demanded of the engine control below atmospheric pressure. However, there may easily be a re-opening of the regulation valve in the first duct and a rapid return to an operation in which most of the exhaust gases pass through the turbine and its rotating element. This can be brought about by an engine control already present in the motor vehicle, an engine control that centralizes all of the operating parameters of the engine assembly in order to control a closing or opening of the regulation valve accordingly.

The fact of preventing the exhaust gases from passing through the turbine via the turbine impeller in the main expansion passage extending the first duct will considerably reduce heat loss from the exhaust gases in the turbine. At least little exhaust gas or even no portion of the exhaust gas will then pass through the main passage inside the impeller while being in contact with a large heat exchange surface represented by the internal surface of the turbine impeller, resulting in less heat loss from the exhaust gases. With a regulation valve closed or partially closed, at least a major part of the exhaust gases after the joining of the extensions in the turbine of the first and second ducts will not have undergone the phenomenon of expansion in the turbine impeller with a reduction in temperature and pressure.

Preferably, the exhaust gas flow regulation valve can be controlled in order to regulate the total flow of gas within the entire range from 0% to 100%. The fact that the entire flow of gases can be regulated, from 0% (valve closed) is highly advantageous because it makes it possible to continue until the turbine stops: a higher exhaust gas temperature can thus be achieved, which can allow quicker activation of the exhaust gas post-treatment units having recourse to catalytic converters (HC and CO oxidation catalytic converters, NOx reduction catalytic converters, etc.) particularly during the start-up phase.

This valve can also be partially closed, blocking x % of the flow, x being any value above 0% and below 100%. Its control commands the operation of the turbine.

Advantageously, the exhaust system comprises a third duct outside the turbine and linked to the outlet face of the turbine casing in order to remove the exhaust gases from the turbine.

Advantageously, the regulation valve is provided with an actuator moving it between at least one first position of closing the main expansion passage with a zero flow in the main expansion passage and one second position of complete opening of the main expansion passage with a maximum flow in the main expansion passage.

Advantageously, the actuator moves the regulation valve into intermediate opening positions corresponding to different flows in the main expansion passage depending on the degree of opening corresponding to each respective intermediate position.

Advantageously, the regulation valve is in the form of a disk that can be moved in translation or rotation by the actuator.

Advantageously, the regulation valve is arranged on at least one outlet end of the main expansion passage on the outlet face of the turbine.

Advantageously, the exhaust system comprises, downstream of the turbine, decontamination elements for the exhaust gases passing through it.

The invention also concerns a method of heating up the decontamination elements in such an engine assembly, wherein, since the decontamination elements need to be heated in order to reach a predetermined minimum temperature to ensure the decontamination treatment, the regulation valve of the main expansion passage keeps the exhaust gas flow in the main expansion passage at a zero or reduced value until said minimum temperature is reached.

Advantageously, a suspensive condition for keeping the flow of exhaust gas passing through the first duct at a zero or reduced value is that the pressure at the engine's air intake is higher than atmospheric pressure.

The subject matter of the invention also concerns a motor vehicle comprising the engine assembly described above.

### DESCRIPTION OF THE DRAWINGS

Further features, aims and advantages of the present invention will emerge from the following detailed description and with regard to the accompanying drawings, given purely by way of non-limiting examples, in which:

FIG. 1 is a schematic representation of a valve event modulated boost engine assembly comprising an exhaust system with two exhaust ducts based on the closest state of the art,

FIG. 2 is a schematic representation of an engine assembly comprising an exhaust system with two exhaust ducts according to an embodiment of the present invention, the turbine being passed through by both ducts,

FIG. 3 is a schematic representation of a longitudinal section of a turbocharger, the turbine of the compressor forming part of an exhaust system of an engine assembly according to the present invention and FIG. 3a shows an embodiment of the inlet face of the turbine,

FIG. 4 is a schematic representation in perspective of another embodiment of a turbine provided with a casing, this turbine forming part of the exhaust system of the engine assembly according to the present invention and incorporating a regulation valve,

FIGS. 5 and 5a are schematic representations of a view of the outlet face of a turbine provided with a regulation valve according to FIG. 4, the regulation valve being shown in these Figures in the closed position and in the open position respectively, this turbine forming part of the exhaust system of the engine assembly according to the present invention,

FIG. 6 is a schematic representation in perspective of another embodiment of a turbine provided with a casing, this turbine forming part of the exhaust system of the engine assembly according to the present invention and incorporating a regulation valve,

FIGS. 7 and 7a are schematic representations of a view of the outlet face of a turbine provided with a regulation valve according to FIG. 6, the regulation valve being shown in the closed position and in the open position respectively in these Figures, this turbine forming part of the exhaust system according to the present invention.

It should be borne in mind that the Figures are given by way of example and are non-limiting as regards the invention. They constitute schematic representations of principle intended to facilitate an understanding of the invention and are not necessarily to the scale of practical applications. In particular, the dimensions of the different elements shown are not representative of reality.

### DETAILED DESCRIPTION

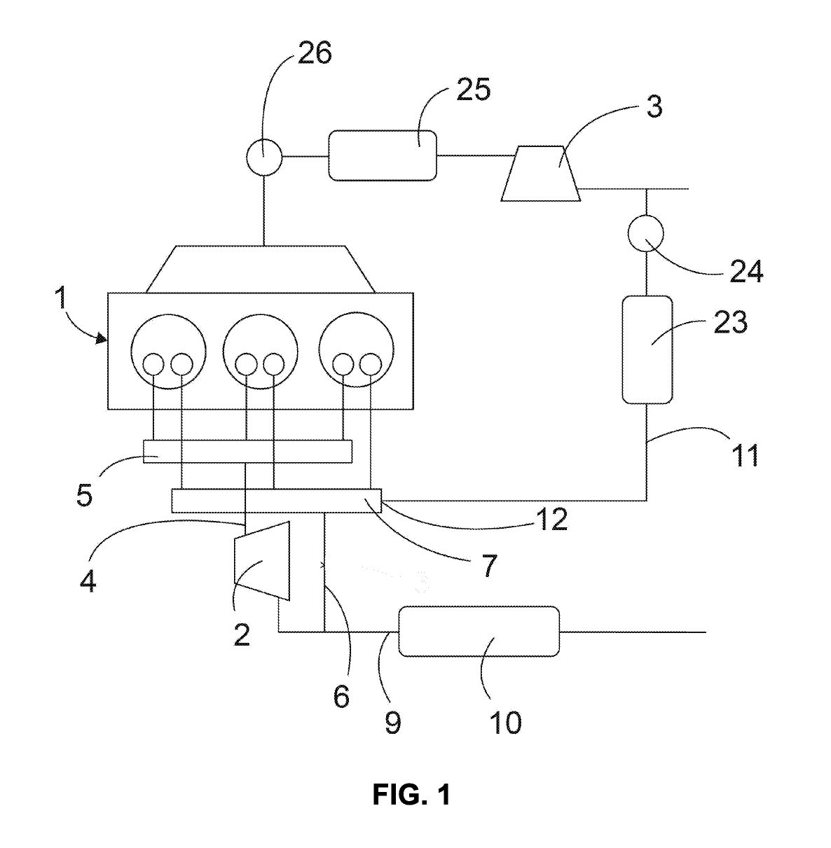

FIG. 1 has already been described in the introductory part of this patent application.

In what follows, the words downstream and upstream are to be understood in relation to the direction of flow of the exhaust gases out of the engine or back towards the engine intake for the recirculation line, an element in the exhaust system downstream of the engine being further away from the engine than another element located upstream of the element. That which is called the engine assembly comprises the combustion engine as well as its auxiliaries for the intake of air into the engine and for the exhaust of gases out of the engine, a turbocharger also forming part of the engine assembly, the turbine being included in the exhaust system of the engine assembly.

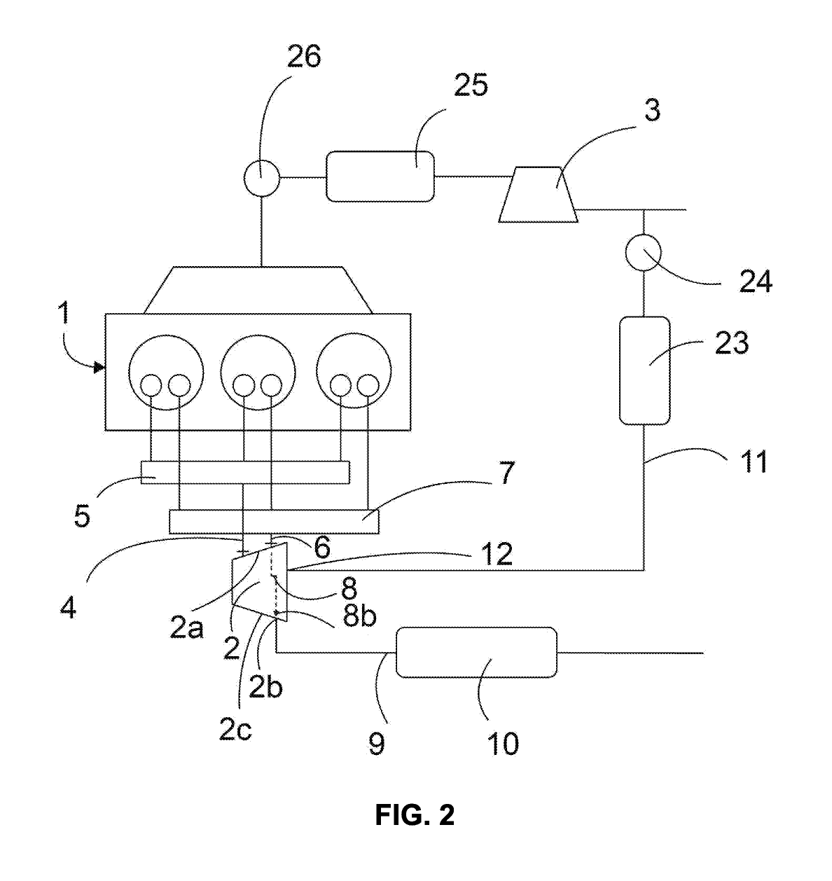

With reference to all of the Figures except for FIG. 1 and particularly to FIG. 2, an engine assembly according to the present invention is shown that includes certain characteristics of an engine assembly of the closest state of the art.

The engine assembly comprises an internal combustion engine with at least one cylinder and a turbocharger comprising a turbine 2 and a compressor 3. The turbine 2 comprises an impeller recovering at least partially the kinetic energy of the exhaust gases passing through it and transmits this energy to the compressor 3.

For this purpose, the turbocharger is provided with a shaft linking the impeller of the turbine 2 to an impeller located in the compressor 3, this organ ensuring the compression of the air passing through the compressor 3. This shaft can be lubricated, cooled by water and/or oil and mounted on bearings with or without rollers. This shaft can also be provided with an electrical assistance, either directly on the shaft or with the aid of gears, for example a transmission or a gearbox.

The exhaust system is connected to an engine outlet in order to remove the exhaust gases resulting from the combustion in the engine and comprises a first so-called exhaust duct 4 through the turbine 2 leading from a first exhaust manifold 5 and a second so-called discharge duct 6 leading from a second exhaust manifold 7. The first and second manifolds 5, 7 are linked to the outlet of the internal combustion engine in order to channel the exhaust gases through the first and second ducts 4, 6. The engine cylinder or each engine cylinder can have at its outlet two outlet passages closed by a respective exhaust valve but this is not compulsory.

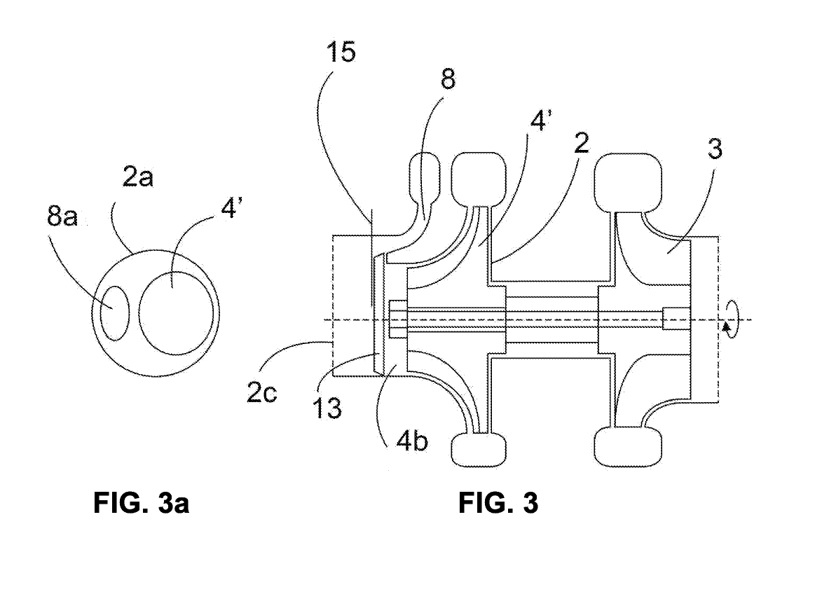

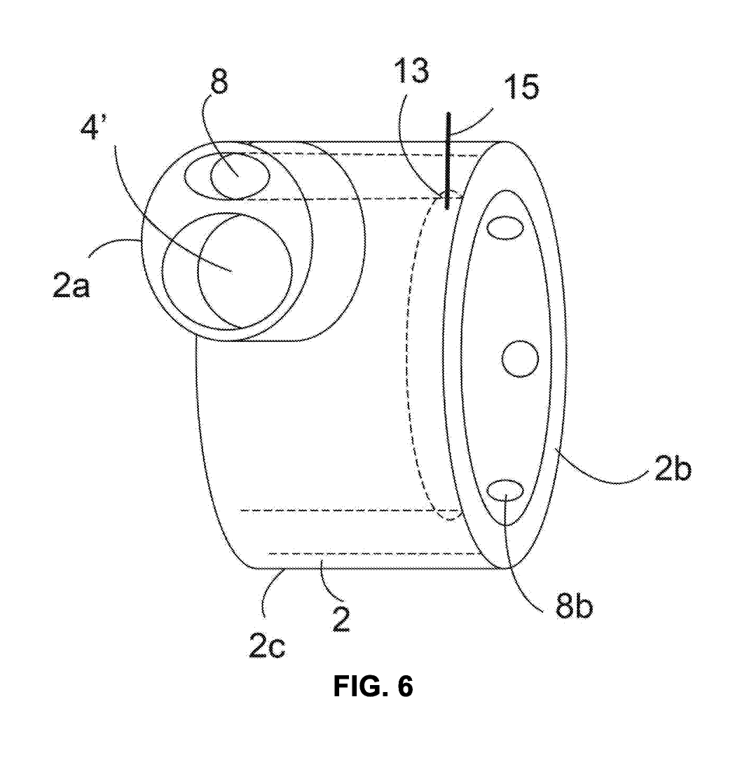

The two exhaust manifolds 5, 7 can be positioned close together in order to be connected to the turbine 2, for example by a flange on the exhaust manifold connecting with a flange provided on a casing 2c of the turbine 2, the casing 2c being particularly visible in FIGS. 3 and 6. The exhaust manifolds 5, 7 can be cooled by a cooling fluid, specifically water, the liquid circulating in a cooling circuit being common or not common to both manifolds 5, 7. The cooling circuit or circuits can also serve to cool the inside of the turbine 2.

Downstream of the turbine 2, in a known way, a third exhaust duct 9 outside the turbine is provided with decontamination elements 10 that should be brought to and kept at a minimum operating temperature.

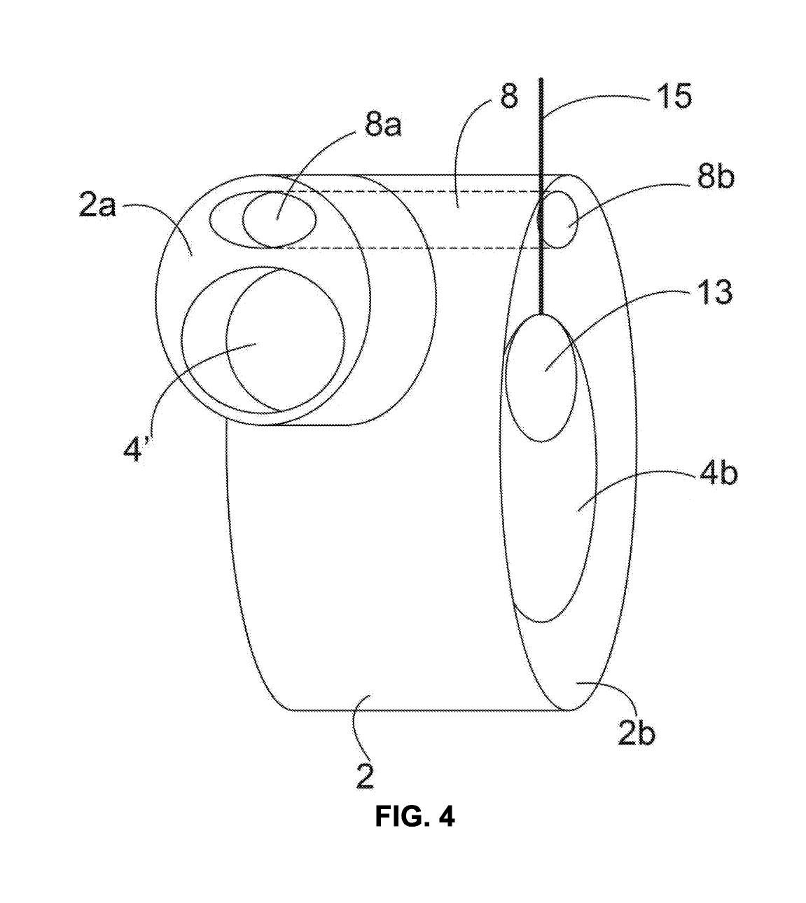

With regard specifically to FIGS. 2, 3, 4 and 6, the turbine 2 of the turbocharger is incorporated in a casing 2c having at least one inlet face 2a for the exhaust gases of the first and second manifolds 4, 6 penetrating into the turbine 2 and one outlet face 2b for the exhaust gases leaving the turbine 2. The turbine 2 has a main expansion passage 4′ in which is housed a turbine impeller and the first duct 4 opens into the main expansion passage 4′ through the inlet face 2a of the casing 2c. The main expansion passage 4′ is particularly visible in FIGS. 3, 4 and 6.

Thus, according to the present invention, the second duct 6 opens through the inlet face 2a of the casing 2c into at least one bypass portion 8 inside the casing 2c bypassing the main expansion passage 4′, the main expansion passage 4′ and said at least one bypass portion 8 joining at an outlet face 2b of the casing 2c, the main expansion passage 4′ comprising, inside the turbine 2, a regulation valve 13 of the flow of exhaust gas passing through it.

Thus, a bypass portion 8 extending the second duct 6 is incorporated into the turbine 2 but does not exchange kinetic energy with the impeller of the turbine 2, which has a more efficient discharge effect on the turbine 2 than the discharge effect achieved with a discharge valve. Lastly, the stronger the flow in the second duct 6 compared to the flow in the first duct 4, the hotter the exhaust gases leaving the turbine 2, which reduces the time required to increase the temperature of the decontamination elements 10 located downstream of the turbine.

The regulation valve 13 advantageously allows the flow in the main expansion passage 4′ extending the first so-called exhaust duct 4 in the turbine 2 to be reduced and/or stopped and thus the temperature of the gases after the joining of the extensions of the first and second ducts 4,6 in the turbine, that are the main expansion passage 4′ and said at least one bypass portion respectively, to be increased. Passing the respective extensions 4′, 8 of the two exhaust ducts 4, 6 through the turbine 2 also ensures better heat insulation of the second duct 6 than in the state of the art. The shortening of the second duct 6 achieved by passing through the turbine 2 helps to reduce loss of heat from the gases passing through the second duct 6.

A secondary advantage of the exhaust system of the engine assembly 1 according to the present invention, due to the fact that a bypass portion 8 extending the second duct 6 is incorporated into the turbine 2, is to reduce the space occupied by the exhaust system and reduce the cost of material for the second duct 6, the joining of the extension of the first and second ducts 4, 6 taking place in the turbine 2 and not after the turbine 2, resulting in a shortening of the length of the second duct 6 which need not be of a length enabling it to bypass the turbine 2.

The main expansion passage 4′ and said at least one bypass portion 8 extending the first and second ducts 4, 6 respectively can open out at the same level of the turbine 2 on the outlet face 2b of the casing 2c. The exhaust system can comprise a third duct 9 outside the turbine 2 and linked to the outlet face 2b of the turbine casing 2c in order to remove the exhaust gases from the turbine 2.

In the embodiment shown in the Figures, except for FIG. 1, the turbine 2 thus comprises an inlet face 2a for the exhaust gases of the first and second ducts 4, 6 penetrating via their extensions 4′, 8 into the turbine 2 and an outlet face 2b connected externally to the third duct 9 outside the turbine 2.

According to a characteristic of the present invention, the main expansion passage 4′ inside the turbine 2 is provided with a regulation valve 13. This regulation valve 13 can advantageously be located near the outlet face 2b of the turbine 2, selectively shutting off or opening an outlet end 4b of the main expansion passage 4′, thus being located in the main expansion passage 4′ after the impeller of the turbine 2.

Whatever its position in the main expansion passage 4′ extending the first duct 4, the regulation valve 13 can be provided with an actuator 15 moving it between at least a first position of closing the main expansion passage 4′ with a zero flow in the main expansion passage 4′ and a second completely open position of the main expansion passage 4′ with a maximum flow in the main expansion passage 4′.

The zero flow in the main expansion passage 4′ can correspond to a demand for heating the decontamination elements 10 while the maximum flow in the main expansion passage 4′ can correspond to a demand for maximum power to the compressor 3 of the turbocharger.

The actuator 15 can also move the regulation valve 13 into intermediate opening positions corresponding to different flows in the main expansion passage 4′ depending on the degree of opening corresponding to each respective intermediate position.

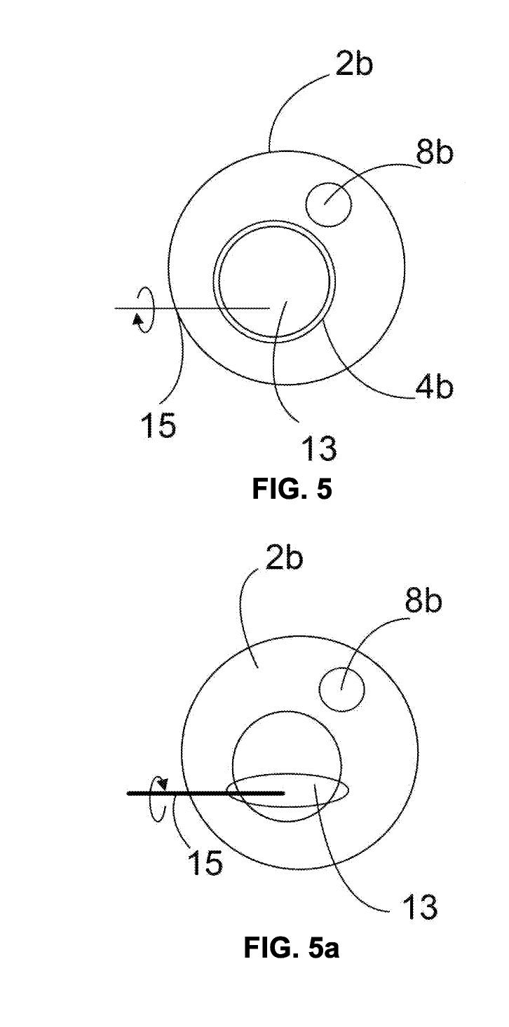

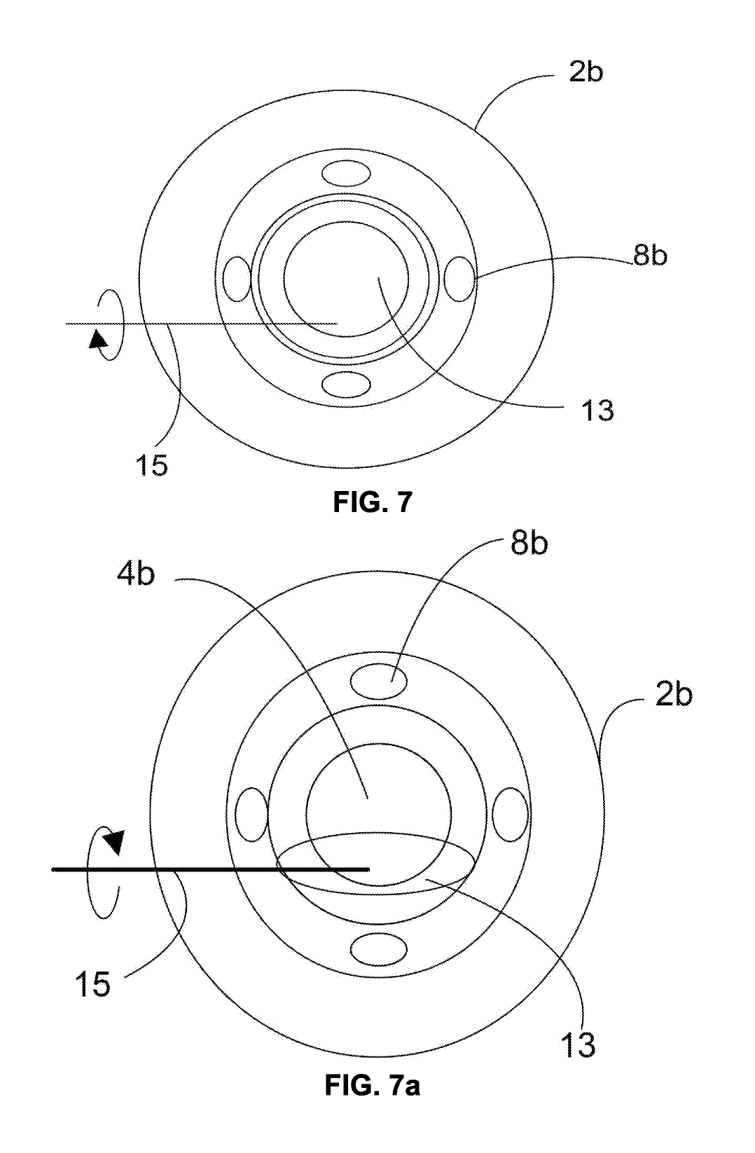

Advantageously, the regulation valve 13 can be in the form of a disk that can be moved by the actuator 15 in translation or rotation. A disk that can be moved in rotation as a regulation valve 13 is shown specifically in FIGS. 5, 5a, 7 and 7a.

Referring to all of the Figures, except FIG. 1, the bypass portion 8 extending the second duct 6 can have an outlet end 8b and the main expansion passage 4′ of the first duct 4 can have an outlet end 4b, the two outlet ends 4b, 8b opening out near the outlet face 2b of the turbine 2, in other words upstream of this outlet face 2b in the turbine 2. The third duct 9, outside the turbine 2, leads from the outlet face 2b in order to remove the exhaust gases from the turbine 2. In a conventional manner, the third duct 9 comprises further downstream of the outlet face 2b of the casing 2c of the turbine 2 decontamination elements 10 for the exhaust gases passing through it, these decontamination elements 10 having been mentioned previously.

It must be borne in mind that several bypass portions 8 extending the second so-called discharge duct 6 can exist simultaneously and that one bypass portion 8 can have several outlet ends 8b. FIGS. 3, 3a, 4, 5 and 5a show one outlet end 8b for one bypass portion 8 while FIGS. 6, 7a and 7b show several outlet ends 8b for one or more bypass portions 8.

The main expansion passage 4′ extending the first duct 4 can also have an outlet end 4b in the place where the main expansion passage 4′ and the bypass portion or portions 8 join. The outlet end 4b of the main expansion passage 4′ can have a larger section than the section of the outlet end or ends 8b of the bypass portion or portions 8 but this is not compulsory. The outlet end 4b of the main expansion passage 4′ advantageously has a circular section, which is not, however, limiting.

For example, the bypass portion or portions 8 can comprise at least two outlet ends 8b. This is shown specifically in FIGS. 6, 7 and 7a. Multiple outlet ends 8b for the bypass portion 8 extending the second discharge duct 6 can be located in a plane parallel to or aligned with that of the outlet face 2b of the turbine 2.

In a first non-limiting embodiment of the invention, the two or more than two outlet ends 8b of a bypass portion 8 can be located adjacent to one another in the turbine 2, which is not shown in the Figures. Alternatively, in a second also non-limiting embodiment of the invention, the two outlet ends 8b of the bypass portion or portions 8 can be distributed uniformly round an outlet disk arranged around the outlet end 4b of the main expansion passage 4′ thus being located in the center of the disk, as shown in FIGS. 6, 7a and 7b.

The two or more than two outlet ends 8b of said at least one bypass portion 8 can open out radially or axially in relation to the outlet end 4b of the first duct 4. A radial opening out with a uniform distribution optimizes the configuration of the casing 2c and associated turbine 2 as well as optimizing the turbulences on the outlet face 2b of the casing 2c of the turbine 2.

In this embodiment, the two or more than two outlet ends 8b of the bypass portion or portions 8 can be at least three in number, all opening out radially or axially or some of the outlet ends 8b opening out radially and some of the other outlet ends 8b opening out axially. This is shown in FIGS. 6, 7 and 7a.

With a second so-called discharge duct 6 extended into the turbine 2 by one or more bypass portions 8, themselves having one or more outlet ends 8b and a main expansion passage 4′ extending the first so-called exhaust duct 4 through the turbine provided with an outlet end 4b, the section of the outlet ends 8b, 4b can have various different forms namely, for example:
a round form such as, for example, in a conventional turbocharger system,
an optimized form to optimize the turbine assembly 2 and its associated casing 2c and to optimize the turbulences at the outlet face 2b of the turbine 2, for example a crescent, half-moon, ovalized, square, rectangular, triangular form, etc.

In an embodiment of the invention, the engine outlet can comprise at least one cylinder equipping the engine and advantageously three, first and second outlet passages closed by a respective exhaust valve, a series of first outlet passages of the cylinders supplying, via the first outlet manifold 5, the first so-called exhaust duct 4 through the turbine and a series of second outlet passages, via the second outlet manifold 7, supplying the second so-called discharge duct 6.

Thus, it is possible to obtain multiple regulations of exhaust gas flows. In specific conditions of operation of the engine assembly 1, it is advantageous to close or reduce the flow of exhaust gas in the main expansion passage 4′ of the turbine 2. This is done by closing at least partially the regulation valve 13 according to the present invention.

It may also be possible to regulate the flow in the first duct 4 and to regulate that of the second duct 6, which allows an improved operation of the engine assembly.

The first specific conditions of operation of the engine assembly 1 will now be described, for which it is advantageous to shut off or reduce the flow of exhaust gas through the regulation valve 13 in the main expansion passage 4′ extending the first duct 4.

As previously stated, the exhaust system comprises, upstream of the turbine 2, decontamination elements 10 for the exhaust gas passing through it, these being located in the third duct 9. These decontamination elements 10 need to be heated by being passed through by exhaust gases as hot as possible in order to reach as soon as possible a predetermined minimum temperature to ensure the decontamination treatment. This is particularly important during the period of time following the start-up of the motor vehicle.

It is advantageous to close or reduce the flow of exhaust gas in the main expansion passage 4′ extending the first duct 4, this flow losing a great deal of heat in the impeller of the turbine 2 and thus being cooler than the flow in the second duct 6 having bypassed the turbine 2.

The invention thus also concerns a method of heating up the decontamination elements 10 in the exhaust system of an engine assembly described above, wherein the regulation valve 13 keeps the exhaust gas flow in the main expansion passage 4′ inside the turbine 2 at a zero or reduced value until said minimum temperature is reached.

In the method according to the present invention, a suspensive condition for keeping the flow of exhaust gas in the main expansion passage 4′ at a zero or reduced value is that the pressure at the engine's air intake is higher than atmospheric pressure. This corresponds to a demand for power of the engine assembly 1.

Incidentally, as shown in FIG. 2, an EGR line can be connected via a branch point 12 to one of the two ducts 4, 6 or to one of their respective extensions in the turbine 2. FIG. 2 shows a branch point 12 of an EGR line 11 through the turbine 2 either with the main expansion passage or with at least one bypass portion 8 or with both.

As previously mentioned, the turbine 2 can be provided with a cooling circuit using a cooling liquid within it, specifically water. This circuit is not shown in the Figures but by referring to FIGS. 2 to 7a for the references of the other elements, the cooling circuit can extend inside the casing 2c at least around the inlet face 2a and around the impeller of the turbine 2.

The cooling liquid advantageously circulates in all of the hot areas where a risk of melting of the material of the casing 2c and the turbine 2 is identified. The circulation of the cooling liquid occurs globally in one direction while travelling all round the casing 2c or the turbine 2, mainly in the area of an inlet flange of the turbine 2 and in the area around the impeller of the turbine 2.

Several preferred embodiments of the cooling circuit are possible. Thus, when the first 5 or the second 7 exhaust manifold comprises a cooling circuit, its cooling circuit can be connected to the cooling circuit of the turbine 2, with an inlet and outlet of the cooling circuit of the turbine 2 possibly located on the inlet face 2a of the turbine 2. In another embodiment, the cooling circuit of the turbine 2 is independent of that of each exhaust manifold 5, 7 and belongs to it. It is also possible for the turbine to be directly connected to the exhaust manifolds 5, 7 of the first and second ducts 4, 6 being then incorporated into their respective manifold 5, 7.

The invention is in no way limited to the embodiments described and illustrated, which have been given purely by way of example.

1. An engine assembly comprising an internal combustion engine with at least one cylinder, a turbocharger comprising a turbine and a compressor, and an exhaust system connected to an engine outlet in order to remove the exhaust gases resulting from the combustion in the engine, the exhaust system comprising a first so-called exhaust duct through the turbine leading from a first exhaust manifold and a second so-called discharge duct leading from a second exhaust manifold, the turbine being provided with a casing having a main expansion passage in which is housed a turbine impeller and the first duct opening into the main expansion passage through an inlet face of the casing, characterized in that the second duct opens through the inlet face of the casing into at least one bypass portion inside the casing bypassing the main expansion passage, the main expansion passage and said at least one bypass portion joining at an outlet face of the casing, the main expansion passage comprising, inside the turbine, a valve for regulating the flow of exhaust gas passing through it.

2. The assembly according to claim 1, wherein the exhaust gas flow regulation valve can be controlled in order to regulate the total flow of gas within the entire range from 0% to 100%.

3. The assembly according to claim 1, wherein the exhaust system comprises a third duct outside the turbine and linked to the outlet face of the turbine casing in order to remove the exhaust gases from the turbine.

4. The assembly according to claim 1, wherein the regulation valve is provided with an actuator moving it between at least one first position of closing the main expansion passage with a zero flow in the main expansion passage and one second position of complete opening of the main expansion passage with a maximum flow in the main expansion passage.

5. The assembly according to claim 4, wherein the actuator moves the regulation valve into intermediate opening positions corresponding to different flows in the main expansion passage depending on the degree of opening corresponding to each respective intermediate position.

6. The assembly according claim 4, wherein the regulation valve is in the form of a disk that can be moved in translation or rotation by the actuator.

7. The assembly according to claim 1, wherein the regulation valve is arranged on at least one outlet end of the main expansion passage on the outlet face of the turbine.

8. The assembly according to any claim 1, wherein the exhaust system comprises, downstream of the turbine, decontamination elements for the exhaust gases passing through it.

9. A method of heating up the decontamination elements in an engine assembly according to the claim 8, wherein, since the decontamination elements need to be heated in order to reach a predetermined minimum temperature to ensure the decontamination treatment, the regulation valve of the main expansion passage keeps the exhaust gas flow in the main expansion passage at a zero or reduced value until said minimum temperature is reached.

10. The method according to claim 9, wherein a suspensive condition for keeping the flow of exhaust gas in the main expansion passage at a zero or reduced value is that the pressure at the engine's air intake is higher than atmospheric pressure.

11. A motor vehicle wherein it comprises the assembly according to claim 1.
